(19) United States
(12) Patent Application Publication
(10) Pub. No.: US 2007/0050232 A1
(43) Pub. Date: Mar. 1, 2007

(54) Method and system for enterprise monitoring based on a component business model

(76) Inventors: Hung-yang Chang, Scarsdale, NY (US); David Bernard Flaxer, Dobbs Ferry, NY (US); Vijay Sourirajan Iyengar, Cortlandt Manor, NY (US); Jun-Jang Jeng, Armonk, NY (US); Anil Nigam, Stamford, CT (US); Guy Jonathan James Rackham, New York, NY (US); John George Vergo, Yorktown Heights, NY (US)

Correspondence Address: Whitham, Curtis, & Christofferson, P.C., Suite 340, 11491 Sunset Hills Road, Reston, VA, 20190, US

(21) Appl. No.: 11/212,105

(22) Filed: Aug. 26, 2005

(51) Int. Cl. G06F 17/30

(52) U.S. Cl. 705/10

(57) ABSTRACT

A method and system for enterprise monitoring maps monitor events to elements of a component business model of the enterprise and displays the mapped events using the component business model. Rules are used to determine whether events captured from a monitor source are monitor events. An enterprise monitor metamodel linking monitor artifacts and elements of a component business model is used to annotate monitor events with data from the component business model of the enterprise.

This invention is related to commonly owned patent application Ser. No. 11/176,371 for “SYSTEM AND METHOD FOR ALIGNMENT OF AN ENTERPRISE TO A COMPONENT BUSINESS MODEL” which is incorporated by reference herein.

### BACKGROUND OF THE INVENTION

1. Field of the Invention

The present invention generally relates to component based business models and, more particularly, to techniques for monitoring the enterprise based on a component business model framework.

2. Background Description

Managers of very small businesses may be able to grasp their entire business situation from their own knowledge and operating experience. They are rather like bush pilots, able to fly by the seat of their pants. Larger enterprises do not have that luxury, and must develop alternative mechanisms for getting a clear picture of the condition of the business. The business itself is like a commercial airliner flying at night or in bad weather, requiring instruments to navigate. The monitoring systems of the business have been developed in response to this need, but there are a variety of such systems and they may be neither comprehensive nor coordinated. Individual managers within the business may be more or less successful at developing suitable monitoring mechanisms within their own areas of responsibility. Within the enterprise there is a wide and disparate range of managers that need to monitor the business, including those involved in the management of: business strategy, business operations, IT operations, computer center management, facility management and management of individual units of enterprise. The challenge, however, is to provide suitable monitoring for the enterprise as a whole.

In order to provide the managers of the enterprise better ways of identifying and analyzing problems or “conditions of interest” (not necessarily errors but reflect situations and states that the business is interested in), exception and condition of interest events and alerts of all types (including business operations, IT infrastructure application facilities, etc.) need to be monitored and the results of this monitoring must be presented within a business organization context. Otherwise there is no way for the business operation team to fully understand the nature of issues that may arise. For example, key performance indicators (KPI's) do not in themselves provide sufficient information to understand the business problem. Strategic objectives need to be validated on an ongoing basis using active operational information. In another example, an exception reported by a business application may be caused by the catastrophic shutdown of a system due to an electrical failure.

To achieve these objectives it is not sufficient for the individual managers of the enterprise to see monitoring results within a business organization context. The business organization context must be the same common context for all the various role players within the enterprise. Otherwise the enterprise as a whole cannot have a clear vision, which is the purpose of enterprise monitoring. Without this common business organization context the business operation team as a whole will not be able to fully understand the nature of business issues, and the members of the team will not be able to communicate effectively on how best to resolve these issues.

Single pieces of data, such as Key Performance Indicators (KPI's), exceptions, failure reports or other reported conditions of interest, do not in themselves provide sufficient information to understand the business problems that arise. Enterprise monitoring information needs to be aggregated and correlated within a common organizing framework to make sense of the many diverse conditions that occur within an enterprise. Furthermore, strategic objectives, business operations and information technology (IT) realization and performance need to be validated on an ongoing basis using active enterprise monitoring information.

### SUMMARY OF THE INVENTION

One aspect of the invention is a method for monitoring an enterprise, comprising mapping at least one message from a monitor source to at least one element of a component business model and presenting monitoring information from the mapping to a user of the enterprise. In another aspect of the invention the mapping further comprises listening to a message from a monitor source, capturing an event from the message, using an event rule to determine if said event is a monitor event, and, if the event is a monitor event, annotating the monitor event with component business model data. In yet another aspect of the invention, the presenting further comprises displaying the monitoring information on a component business map of the enterprise. In another variation, the presenting further comprises generating a report of the monitoring information, the report being sorted by elements of a component business model.

In a further aspect of the invention, the annotating is based on an enterprise monitor metamodel connecting the message from a monitor source to one or more elements of a component business model. It is also an aspect of the invention for the metamodel to include a monitor artifact element, the monitor artifact element being further comprised of a status level element, a monitor data element, and a monitor correlator element. In another aspect of the invention the mapping is provided by a middleware service.

### BRIEF DESCRIPTION OF THE DRAWINGS

The foregoing and other features, aspects and advantages will be better understood from the following detailed description of a preferred embodiment of the invention with reference to the drawings, in which:

FIG. 1 is a schematic showing a CBM component map as a lens to view business operations monitoring in context.

FIG. 2 is a diagram showing a conceptual model of how monitoring supports operation of the enterprise.

FIG. 3 is a diagram of a metamodel showing mapping of enterprise monitoring to a CBM model.

FIG. 4 is a flow chart showing a method of monitoring an enterprise.

FIG. 5 is a diagram of a system architecture supporting CBM enterprise monitoring.

FIG. 6 is an exemplar display showing an implementation of the invention.

### DETAILED DESCRIPTION OF A PREFERRED EMBODIMENT OF THE INVENTION

It is therefore a feature of the present invention to provide enterprise monitoring systems with a common business organization context.

Another feature of the invention is to provide various role players within the enterprise (including executive management, business operation teams, business analysts, IT architects, and program/project managers) better ways of viewing, identifying and analyzing problems that affect the achievement of business goals and performance of the enterprise.

It is also a feature of the invention to provide an enterprise operation monitoring founded on the CBM organizing framework.

A further feature of the invention is to present enterprise operation monitoring within a CBM interface based on the component map tailored for the enterprise.

It is also a feature of the invention to provide for reports and monitoring displays that present information in context for each of the user roles that comprise the business operation team.

Another feature of the invention is to aggregate and correlate enterprise management conditions to facilitate problem determination, analysis and correction.

A feature of the invention is to cover within the enterprise monitoring umbrella all operational activities including but not limited to business activity monitoring (BAM), key performance indicator (KPI) monitoring, IT system monitoring, IT application monitoring, and other software monitoring.

A related feature of the invention is to extend the enterprise monitoring umbrella to support the monitoring of the physical plant, resource consumption and other examples of utility monitoring not ordinarily connected to the direction of the enterprise as a whole.

It is a feature of the invention to use enterprise operation monitoring to provide reports and information displays usable for validating business strategy, business operational and IT realization aspects of the enterprise.

Another feature of the invention is to ensure that enterprise monitoring also supports the identification, determination and correction of business problems.

The invention uses the Component Business Model (CBM) described in related patent application Ser. No. 11/176,371 for “SYSTEM AND METHOD FOR ALIGNMENT OF AN ENTERPRISE TO A COMPONENT BUSINESS MODEL” (hereafter termed “the above referenced foundation patent application”). CBM provides a logical and comprehensive view of the enterprise, in terms that cut across commercial enterprises in general and industries in particular. The component business model as described in the above referenced foundation patent application is based upon a logical partitioning of business activities into non-overlapping managing concepts, each managing concept being active at the three levels of management accountability: providing direction to the business, controlling how the business operates, and executing the operations of the business. The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes. Third, the managing concept must include mechanisms for doing something commercially useful with the asset. For a sensibly defined managing concept these mechanisms must cover the full range of management accountability levels (i.e. direct, control and execute). Managing concepts are further partitioned into components, which are cohesive groups of activities. The boundaries of a component usually fall within a single management accountability level. It is important to emphasize that the boundaries between managing concepts (and between components within managing concepts) are logical rather than physical.

The invention establishes a metamodel extension that annotates enterprise operation messages, data and events originating from a wide range of existing (or future) monitoring sources, with condition prioritization and explanation that maps this information to CBM components and elements. The invention enables a monitoring display based on the CBM map of the Enterprise, indicating condition prioritization and providing information reports in context for user roles. A new middleware service is implemented, responsible for capturing monitoring conditions from a plurality of sources and mapping them into CBM components and elements. This middleware service obviates the need for existing monitoring sources to change their procedures or data to recognize the CBM model. A new user interface is implemented that provides graphic views or reports of monitoring conditions based on the CBM map of the enterprise.

One aspect of the invention is a method for monitoring an enterprise by mapping at least one message from a monitor source to at least one element of a component business model and presenting monitoring information from the mapping to a user of the enterprise. The details of the mapping involve listening to a message from a monitor source, capturing an event from the message, using an event rule to determine if the event is a monitor event, and if the event is a monitor event, annotating the monitor event with component business model data. The presenting step can display the monitoring information on a component business map of the enterprise, or generate a report of the monitoring information, the report being sorted by elements of a component business model, among other options.

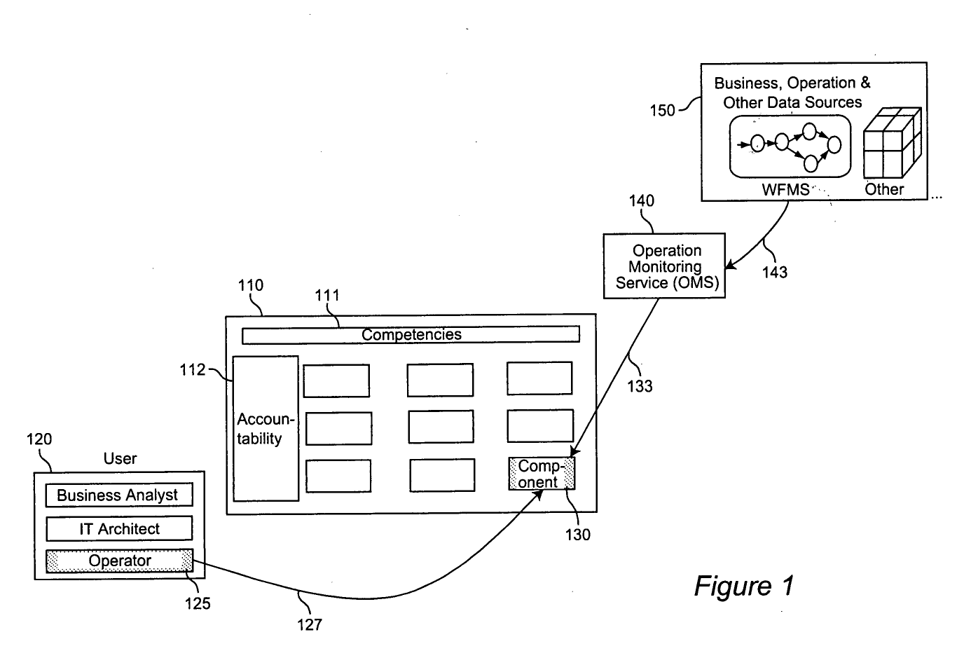

This invention is based on the notion that CBM can be extended to be used as a monitoring framework in which to organize and present information on enterprise conditions. The overall concept is presented in FIG. 1. Applications, services and other programs monitor operations, business activities and other conditions throughout the enterprise. These sources 150 of monitoring information detect conditions and issue messages or reports. In the prior art, without a CBM model, a user 120 of business monitoring information 150 may need to review available data and select from a variety of sources 150 those of greatest interest. However, a typical user (e.g. operator 125) will be interested in only a part of available data 150. A CBM map 110 provides an organization of the business into components arranged by competency 111 and, within a competency 111, further arranged by the level of management accountability 112.

Using the partitioning scheme provided by CBM, the enterprise's variety of business monitoring sources 150 may be parsed into an array of understandable and well organized components. This enables the typical user (e.g. operator 125) to select 127 a narrower set of business activities (represented by a component 130 or even a competency 111) aligned with the user's focus. By mapping the monitoring activities of the enterprise 150 onto the CBM map 110, as explained below, a user 120 is able to limit his examination to those sources 150 of monitoring information mapped to a set of business activities selected by the user.

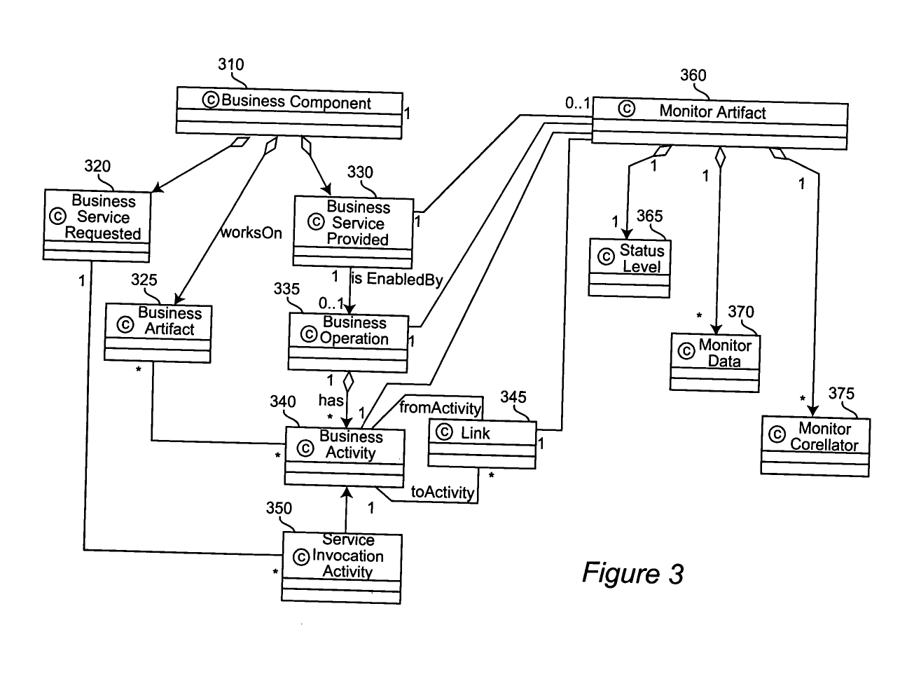

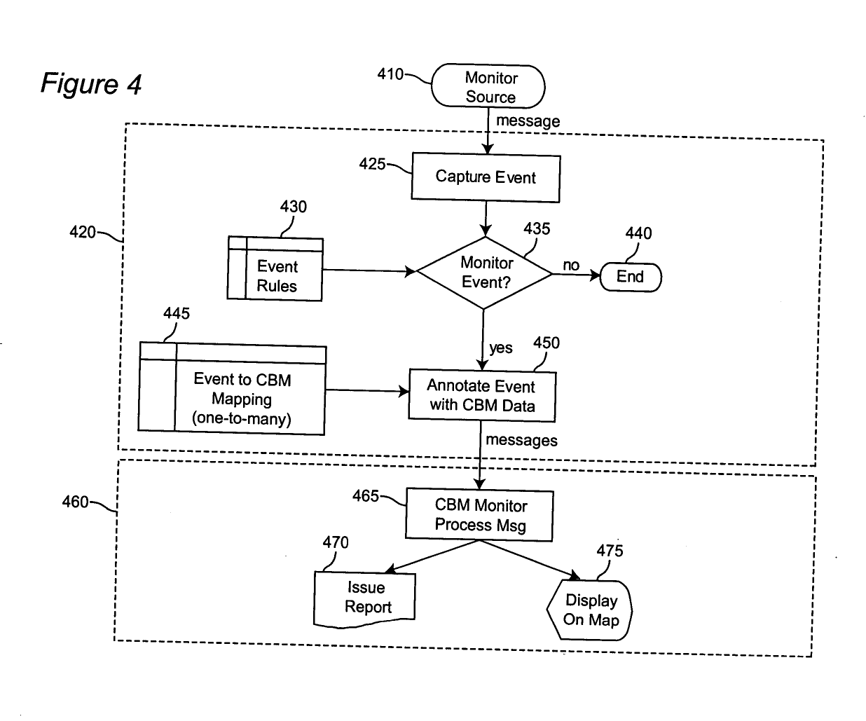

A unique Operational Monitoring Service 140 (OMS) listens 143 for monitoring messages and reports generated by the various monitoring sources 150. It then annotates these messages and reports using a CBM metamodel extension as described below in connection with FIG. 3. Using rule sets (described below in connection with items 430 and 445 in FIG. 4) the OMS maps these messages and reports to CBM components and other CBM structures that are defined within the CBM metamodel. The OMS 140 contains programmatic instructions for identifying these messages and data and looking up the business rules for routing the information. For example, purchasing pattern data will be routed to the “Customer Behavior and Models” component, and data related to credit checks will be routed to the “Credit Administration” component.

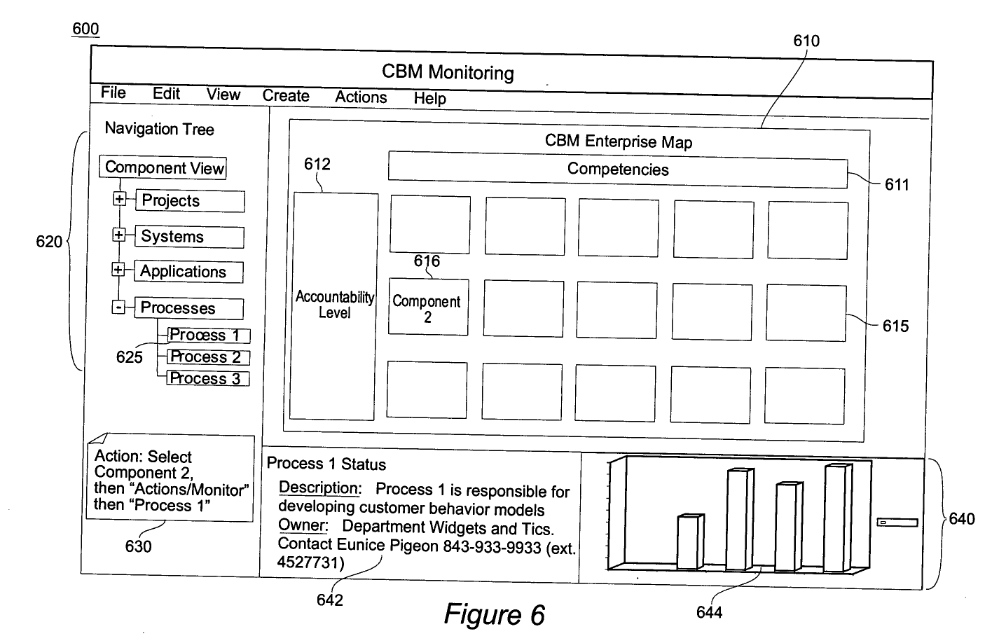

The OMS 140 creates unique messages, annotated with CBM data, which enables the CBM Enterprise Monitor (EM) 110 to display this information. The EM interface is a representation of the CBM map of the enterprise upon which monitoring information status is visually encoded by color or pattern. Monitoring information is captured in the messages generated by the OMS. By selecting visual elements of the CBM map, the user can “drill-down” to obtain detailed information about the monitored condition, as may be seen in connection with the description of FIG. 6, below.

The user 120 may be a member of a wide range of roles from executive to operations manager. The EM presents monitoring information on context to the user role.

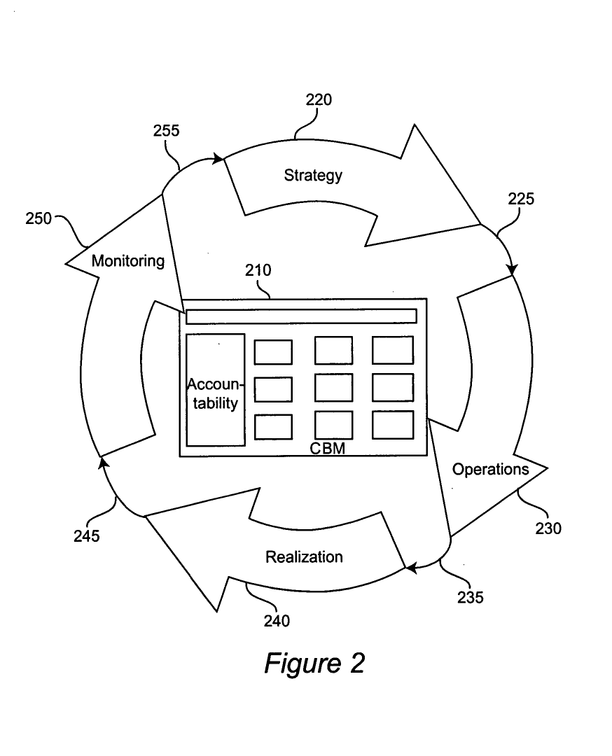

As illustrated in FIG. 2, the holistic view of CBM advances the notion that four key aspects of the enterprise [business strategy 220, business operations 230, realization 240 and monitoring 250] compose a continuum of concerns that are all related and dependent on one another. Business strategy 220 expresses the strategic intent 225 of the enterprise to business operations 230, which specifies 235 business operations and processes, business service agreements and key performance indicators (KPIs). These specifications 235 are realized 240 in particular business processes, including IT systems and applications, IT operations and measures of KPIs. Exceptions or conditions of interest 245 to the realized specifications (e.g. an out of range measure of a KPI) are monitored 250 by a wide range of system, application, business activity and other monitors, which then provide feedback 255 to business strategy 220. This feedback 255 is organized and focused by the CBM lens 210.

Thus, by observing these interacting aspects of the enterprise in their totality, holistically embracing business intent 225, realization 240 and monitoring 250 are seen as being related to, and interdependent with, strategy 220 and operations 230. As a consequence of this perspective on the enterprise, the so-called business-to-IT gap can be seen to be illusory. Shaping the monitoring function to this holistic view of an enterprise significantly improves how the enterprise is organized and managed. This shaping also improves how the enterprise shares data, and also improves how business components react to the information that is provided.

The starting place for setting enterprise objectives and defining the activities of the enterprise lies within the business strategy and executive roles, which articulate the goals and conditions that the operational enterprise must meet. Capturing this business context is critical to the identification and specification of business operations, realization and monitoring. This can include business related information that influences the specification of governance, service agreements and key performance indicators used for monitoring. The key is to capture business specification, operation, realization and monitoring in a formal way, and retain these specifications throughout the continuum shown in FIG. 2, such that the business and operational context is always expressed. This will assure a consistent and holistic coupling between all aspects of the enterprise.

The Component Business Model (CBM) 210 provides a common, consistent and uniform model in which to support all four aspects of the business continuum. CBM provides a wide range of techniques that enable an effective means of identifying and capturing business intent. CBM embodies a model and method that facilitates the analysis of a business enterprise, decomposing it into discrete semi-autonomous and collaborating business components. Contained within these components are sets of requirements that provide specification for the people, processes, technology and other resources that realize the purposes of the component. Further, as the CBM map is rooted in business strategy operations and business service realization, it is a natural step to extend the technique, model and methods to embrace enterprise operational monitoring. This provides critical information about the active operations of the enterprise required for detection, analysis, control and feedback.

Turning now to FIG. 3, the invention provides an enterprise monitor metamodel that describes the relationship between CBM elements (components, services, operations activities and links) and operational monitoring conditions and information. Business component 310 requests business service 320 and provides business service 330. Business component 310 also works on business artifact 325. The business service 330 provided by business component 310 is enabled by business operation 335, which has business activity 340. Business activity 340 is connected both to and from link 345. Business activity 340 is also connected to business artifact 325 and is supported by service invocation activity 350, which in turn supports the business service 320 requested by business component 310.

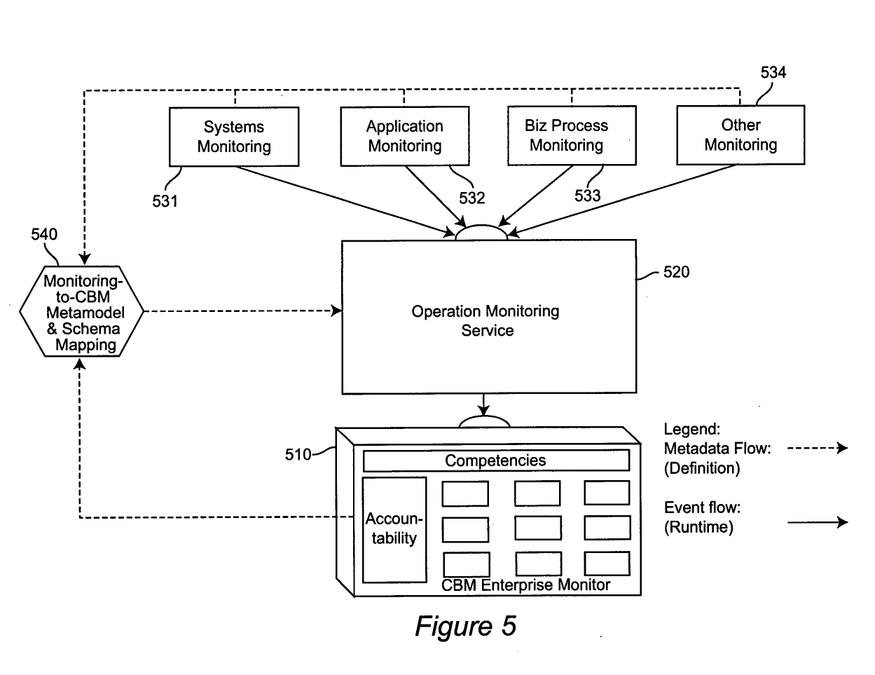

This model is referenced by the OMS 140 to construct messages that are passed to the enterprise monitor (EM as described below in connection with FIG. 5), which interrogates and extracts information contained in data sources 150 throughout the enterprise for display and reporting.

The right side of FIG. 3 shows the monitor artifact 360, which is connected to business component 310, business service 330 provided by business component 310, business operation 335, business activity 340 and link 345. Monitor artifact 360 is a structure that facilitates a normalized view of enterprise operational monitoring information, so that information obtained from various sources throughout the enterprise can be understood in a common framework. The monitor artifact 360 is comprised of a status level 365, monitor data 370 and monitor correlator 375. Status level 365 indicates the importance of an event monitored based on an absolute scale, which determines how the conditions of the event should be displayed in the EM. Monitor data 370 is a structured form that contains specific information on the monitoring conditions. Monitor correlator 375 provides the association needed to tie multiple monitor artifacts together when conditions apply to several CBM elements.

Business component 310 is a well-bounded piece of the enterprise that can be a business in its own right. It includes the resources, people, technology and know-how necessary to deliver the value the business strives to provide. A business service 330 is some well-defined value that a business component offers to other business components and/or to external parties. A business operation 335 describes what the business actually does. It consists of business artifacts 325, business activities 340 (nodes) that work on artifacts 325, and a topology of connections between the business activities, and resources, people and technology that support the activities. A business activity 340 is something the business does at a level of granularity that is chosen by the business. Business activities are related to one another through a link 345 which establishes their relationship. Directed graphs of activities and links form a business operation 335, which can be viewed as the business process that enables a business service 330. A business artifact 325 is a concrete identifiable chunk of business information such as forms, documents and messages. A service invocation activity 350 is a business activity that requires a business service be invoked.

The method of the invention is shown in FIG. 4. In summary, a monitor source 410 is connected by a message to Operational Monitoring Service 420, which in turn is connected by a message to enterprise monitor 460. The objective of the method is to demonstrate how the wide range of business, IT and other conditions in the enterprise are captured as monitor events and processed for presentation. Applications, services and other programs monitor operations, business activities and other conditions throughout the enterprise. These sources 410 of monitoring information detect conditions and issue messages or reports. The Operational Monitoring Service 420 listens for and captures 425 these events. This monitoring is enabled by adaptors or other constructs (not illustrated) that link to and recognize messages to be processed.

In a definitional task, business and IT architects construct rule sets 430 and other programmatic instructions (for example, such as those represented by Event-Action-Condition rules (ECA rules) or other declarative rule forms) that direct the identification and mapping of monitor events 435. These are submitted to the Operational Monitoring Service 420 which uses them to direct message processing as shown in FIG. 4. A monitor event 435 will be evaluated in accordance with a rule 430, to determine whether the monitor event 435 is to be explicitly specified. If a monitor event 435 is not explicitly specified it is discarded 440. If it is explicitly specified it is annotated 450 with CBM data so that the monitor event can be mapped 445, by various means (for example, using spreadsheets, structured files or programmatic instructions in the form of Extensible Stylesheet Language Transformation (XSLT) that enables the ability to transform information marked up in XML from one vocabulary to another) to one or more CBM components.

Using its rule sets and programmatic instructions, the Operational Monitoring Service 420 maps detected conditions to CBM elements and constructs a message (based on the EM Metamodel described above in connection with FIG. 3). The EM 460 receives these messages, which are then processed 465 to extract information for presentation on an interface that displays the CBM map for the enterprise. Outputs of the method are graphic interfaces encoded to display 475 on the CBM map levels of status and information, as well as reports 470 generated on softcopy or paper to be used by the various role players.

FIG. 5 illustrates a preferred embodiment of the invention which utilizes the model and method described above. There are three main elements in this embodiment. First, various monitors (e.g. systems monitoring 531, application monitoring 532, business process monitoring 533, and other monitoring 534) are deployed throughout the enterprise. At runtime these monitors provide monitor events to the Operation Monitoring Service 520. Second, Operation Monitoring Service 520 is a programmed middleware service responsible for capturing monitoring conditions and mapping them into messages understood by the Enterprise Monitor 510. Third, Enterprise Monitor 510 interrogates these messages and displays the extracted information on the interface based on the CBM map of the enterprise.

Note that the various monitors (531, 532, 533, and 534) are defined in terms of the EM metamodel (shown in FIG. 3), which provides the information for the OMS 520 to map monitor events to the appropriate CBM elements, which results in a display of monitor event information on the CBM enterprise monitor, organized by CBM elements. The role of metadata in this definitional linkage between the various monitors and the EM display is signified by item 540, which represents the monitoring-to-CBM metamodel and schema mapping.

Now turning to FIG. 6, there is shown an exemplar display 600 of an implementation of the invention. One pane of the display contains a CBM enterprise map 610 where components (e.g. 615) are arrayed by their respective competencies 611 and accountability levels 612. A second pane of the display 600 shows a navigation tree 620 enabling the user to drill down to a particular aspect (e.g. project, system, application, process) within a CBM element (e.g. component, competency, accountability level). In the example of FIG. 6, the navigation tree 620 shows a component view (i.e. the selected CBM element is the component). In this illustration a component (“Component 2”) 616 indicates (for example by color) that a monitored exception or condition of interest has occurred within its sphere of responsibility. A navigation tree 630 may also be displayed, showing in this example that the user selected a component 616 (“Component 2”), then selected the “Monitor” option (not shown) from the “Actions” pull down menu, and then selected a process 625 (“Process 1” under “Processes” in the navigation tree 620). The monitoring information resulting from these selections is then displayed in another pane 640, and may include both textual information 642 (e.g. describing “Process 1” and indicating the organizational component that is the owner of the selected process) and graphical information 644 (e.g. a time chart showing the status of the process by calendar quarter).

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for monitoring an enterprise, comprising:
mapping at least one message from a monitor source to at least one element of a component business model; and
presenting monitoring information from said mapping to a user of the enterprise.

2. A method as in claim 1, said mapping further comprising:
listening to a message from a monitor source;
capturing an event from said message;
using an event rule to determine if said event is a monitor event; and
if said event is a monitor event, annotating said monitor event with component business model data.

3. A method as in claim 1, said presenting further comprising displaying the monitoring information on a component business map of the enterprise.

4. A method as in claim 1, said presenting further comprising generating a report of the monitoring information, the report being sorted by elements of a component business model.

5. A method as in claim 2, said annotating being based on an enterprise monitor metamodel connecting said message from a monitor source to one or more elements of a component business model.

6. A method as in claim 5, wherein said metamodel includes a monitor artifact element, said monitor artifact element being further comprised of a status level element, a monitor data element, and a monitor correlator element.

7. A method as in claim 2, wherein said mapping is provided by a middleware service.

8. A system for monitoring an enterprise, comprising:
means for mapping at least one message from a monitor source to at least one element of a component business model; and
means for presenting monitoring information from said mapping to a user of the enterprise.

9. A system as in claim 8, said mapping means further comprising:
means for listening to a message from a monitor source;
means for capturing an event from said message;
means for using an event rule to determine if said event is a monitor event; and
means for annotating a monitor event with component business model data.

10. A system as in claim 8, said presenting means further comprising means for displaying the monitoring information on a component business map of the enterprise.

11. A system as in claim 8, said presenting means further comprising means for generating a report of the monitoring information, the report being sorted by elements of a component business model.

12. A system as in claim 9, said annotating means being based on an enterprise monitor metamodel connecting said message from a monitor source to one or more elements of a component business model.

13. A system as in claim 12, wherein said metamodel includes a monitor artifact element, said monitor artifact element being further comprised of a status level element, a monitor data element, and a monitor correlator element.

14. A system as in claim 9, wherein said mapping means is implemented by a middleware service.

15. Implementing a service for monitoring an enterprise, comprising the method of:
mapping at least one message from a monitor source to at least one element of a component business model; and
presenting monitoring information from said mapping to a user of the enterprise.

16. A method for implementing a monitoring service as in claim 15, said mapping further comprising:
listening to a message from a monitor source;
capturing an event from said message;
using an event rule to determine if said event is a monitor event; and
if said event is a monitor event, annotating said monitor event with component business model data.

17. A method for implementing a monitoring service as in claim 15, said presenting further comprising displaying the monitoring information on a component business map of the enterprise.

18. A method for implementing a monitoring service as in claim 15, said presenting further comprising generating a report of the monitoring information, the report being sorted by elements of a component business model.

19. A method for implementing a monitoring service as in claim 16, said annotating being based on an enterprise monitor metamodel connecting said message from a monitor source to one or more elements of a component business model.

20. A computer implemented system for monitoring an enterprise, comprising:
first computer code for mapping at least one message from a monitor source to at least one element of a component business model; and
second computer code for presenting monitoring information from said mapping to a user of the enterprise.

21. A computer implemented system as in claim 20, said first computer code for mapping further comprising:
third computer code for listening to a message from a monitor source;
fourth computer code for capturing an event from said message;
fifth computer code for using an event rule to determine if said event is a monitor event; and
sixth computer code for annotating a monitor event with component business model data.
